(19) United States
(12) Patent Application Publication
(10) Pub. No.: US 2008/0201311 A1
(43) Pub. Date: Aug. 21, 2008

(54) Systems and methods for channeling client network activity

(75) Inventors: Kent Ertugrul, London (GB); Anton Roslov, London (GB)

Correspondence Address: ALLEMAN HALL MCCOY RUSSELL & TUTTLE LLP, 806 SW BROADWAY, SUITE 600, PORTLAND, OR, 97205-3335, US

(73) Assignee: PHORM UK, INC., London (GB)

(21) Appl. No.: 11/963,625

(22) Filed: Dec. 21, 2007

Related U.S. Application Data
(60) Provisional application No. 60/876,886, filed on Dec. 22, 2006.

(51) Int. Cl. G06F 15/173; G06F 7/06; G06F 17/30; G06F 15/16; G06Q 30/00

(52) U.S. Cl. 707/4; 709/224; 709/201; 707/100; 705/35; 705/14; 707/E17.017

(57) ABSTRACT

As one example, a system for monitoring client Internet activity is provided. The system comprises a channel server including multiple channels, each of which are defined at least in part by an activity profile associated with the channel, and a monitor configured to monitor Internet activity of a plurality of clients and detect when any of the monitored clients satisfy any of the activity profiles associated with the channels, where for a given user, the monitor is configured to monitor interaction of the user in relation to multiple different independent websites to determine if one of the activity profiles is satisfied.

### CROSS-REFERENCE TO RELATED APPLICATION

This application claims the benefit of U.S. Provisional Patent Application No. 60/876,886, filed Dec. 22, 2006, which is hereby incorporated by reference in its entirety for all purposes.

### BACKGROUND

The present description is directed to systems and methods for acquiring and using information about the way computer users interact with networks such as the Internet. With limited exceptions, the Internet is a stateless system. Interactions between client users and network resources typically occur without historical context or memory of prior transactions. For example, web servers are designed to engage in stateless transactions with clients that request pages from the server. Since the server does not maintain dynamic memory allocations relating to prior transactions with the client, client requests must include a complete specification of the page(s) to be displayed at the client browser.

In many cases, this stateless quality simplifies network communications and architecture. Among other things, various standardization benefits can be achieved through stateless designs, and as referenced above, storage resources do not have to be dynamically allocated to pending client conversations. On the other hand, the pervasive statelessness of the Internet reduces the ability to efficiently provide individually relevant user experiences.

Use of cookies provides some ability to create conversational memory in Internet transactions, although there are significant limitations. One limitation is that the context created by a cookie is generated through interaction of a client with a particular website, and the customization benefit is only achieved in relation to that website or cooperating affiliates. Cookies must also be stored locally, and by definition, their use requires transmission and interpretation of additional information beyond the base request.

The present description provides a different approach to making and using observations about Internet activity. The described systems and methods provide a unique and powerful tool for learning about Internet behavior, which can be applied to advantage in diverse settings. One broad class of applications involves efficiently reducing the statelessness of the Internet. An example of such an application is to employ observational data to deliver highly relevant targeted advertising material. This is but one of many beneficial applications.

In many examples, the systems and methods include powerful monitoring functionality that can be readily integrated into networking infrastructure. In many implementations, highly granular and detailed activity data can be obtained and correlated to specific users while still adhering to rigorous privacy standards. Acquired data may include demographic, behavioral and contextual information that can be combined in limitless ways to define user states and provide other benefits.

### BRIEF DESCRIPTION OF THE DRAWINGS

FIG. 1 is a schematic illustration of an example data network.

FIG. 2 is a schematic illustration of user states and channels.

FIGS. 3 and 4 depict exemplary tools and interfaces for channel creation, selection and editing.

FIG. 5 is a schematic illustration of exemplary data flows associated with using a channel server system to coordinate delivery of targeted content.

FIGS. 6, 7A and 7B depict exemplary systems and methods for using monitored client behavior to group clients into relevant channels.

FIG. 8 illustrates several example scenarios describing how a channel may be selected, created, modified and shared with another party via a Media Planning Tool.

FIGS. 9 and 10 depict further exemplary tools and interfaces for channel creation, selection and editing.

FIGS. 11 and 12 are flow charts illustrating example methods of managing channel creation and access.

FIG. 13 is a flow chart illustrating an example routine that may be performed to assess whether a channel is matched to a client.

FIG. 14 is a flow chart illustrating an example routine that may be performed to identify which channel of a plurality of channels may be selected.

FIG. 15 is a flow chart illustrating an example routine that may be used to simulate the performance of a campaign.

FIG. 16 is a flow chart describing a client opt-in/opt-out approach.

FIGS. 17-19 depict exemplary systems and methods for monitoring client network client network activity and determining whether such activity constitutes a channel match.

### DETAILED DESCRIPTION

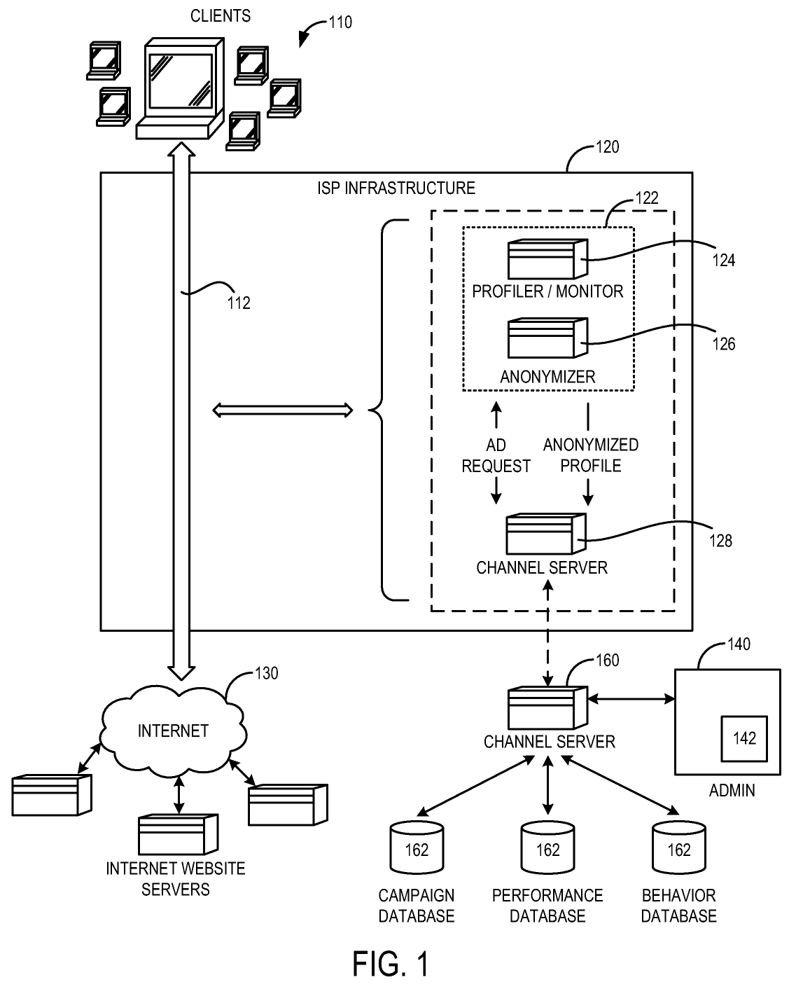

FIG. 1 depicts a group of exemplary client devices 110 coupled to the Internet 120 via Internet Service Provider (ISP) 120. ISP 120 may be dialup, broadband, wireless, satellite-based, etc. In this and the other examples discussed herein, references to ISPs should broadly be understood to denote any infrastructure usable by a client to gain access to the Internet.

One or more monitors 122 are deployed in operative proximity to the client devices. Typically, the monitor is associated with or operated within the infrastructure of ISP 120. It should be understood, however, that a monitor or monitors may be configured in alternate topologies that allow observation of client behavior/interaction relative to the Internet.

In one example, the ISP initiates launching of a context reader into HTTP stream that flows through to the client device. In particular, a script may be embedded into web pages requested by the client. The script executes within the client browser and reads information off of the displayed webpage, such as keywords or other information. The observed/monitored information may be stored locally or otherwise for later use, such as in influencing delivery of a targeted advertisement to the user. In other examples, monitoring and observation processes run within the ISP infrastructure, for example on a server that observes requests and responses of a particular client connecting through the ISP.

The figure is representative of the latter example. In particular, monitor 122 operates within the infrastructure of ISP 120 to observe Internet activity 112 of the clients connected through the ISP. Monitor 122 typically includes various modules and functional components, which may include a profiler 124 and anonymizer 126. As will be discussed in detail below, monitors 122 may be configured to monitor various aspects of client Internet activity. Examples of monitored behavior may include: URLs visited; keywords on viewed pages; frequency and/or positioning of keywords; user entry of keywords into search engines or other search utilities. These are but a few illustrative examples. Further examples of client monitoring may be found in U.S. patent application Nos. 11/377,797, 11/425,698, and 11/901,255, the disclosures of which are incorporated herein by this reference, in their entireties and for all purposes.

Observation of Internet activity, both instantaneously and over time, enables the system to determine if activity of a given client corresponds to one or more predefined states. As explained in detail below, a channel server 128 may also be provided within the ISP to store activity profiles and determine when observed Internet activity corresponds to the defined user states.

In many cases, state definitions will be established via an external administrative function. In particular, as shown in FIG. 1, a channel administrator 140 is operatively coupled with a central channel server group 160 and associated databases 162. Channel administrator includes a user interface 142 which allows an operator to select or create activity profiles, triggering conditions and other parameters for describing and identifying users or groups of users. In a marketing/advertising application, the specified activity profiles typically will describe Internet activity that is likely to be engaged in by a desirable prospective customer.

For example, a seller of photographic equipment would likely be interested in Internet users that had recently visited web pages of certain camera manufacturers, and/or that had viewed multiple pages with a high incidence of relevant keywords (e.g., Canon, Nikon, SLR, CCD, etc.). Channel administrator 140 would enable the seller to establish activity profiles including such criteria. The activity profiles are incorporated into user channels, which are stored and managed within central channel server group 160. The channels are then distributed and activated at enabled ISPs, where the monitoring/observation function operates in conjunction with the local channel server to dynamically identify users that satisfy channels. As an alternative, the monitoring/observation functions may be run external to or outside of ISPs, for example on a dedicated server farm.

It should then be understood that the described system operates in one sense as a solution for searching for user Internet activity. This stands in stark contrast to the ubiquitous content searching offered by Google, Yahoo, etc. Instead, the present system allows an administrator to specify behavior, and then operates to identify users or groups of users engaging in that behavior.

It should be further understood that the example of FIG. 1, which depicts only a single ISP, may constitute only a small portion of an overall system. For example, central channel server group 160 may provide centralized administration and functionality for a plurality of distributed monitoring domains associated with multiple different ISPs. Indeed, the systems contemplated in the present discussion provide ever-increasing advantages to all participants when monitoring and channel matching occur in connection with a large number of ISPs.

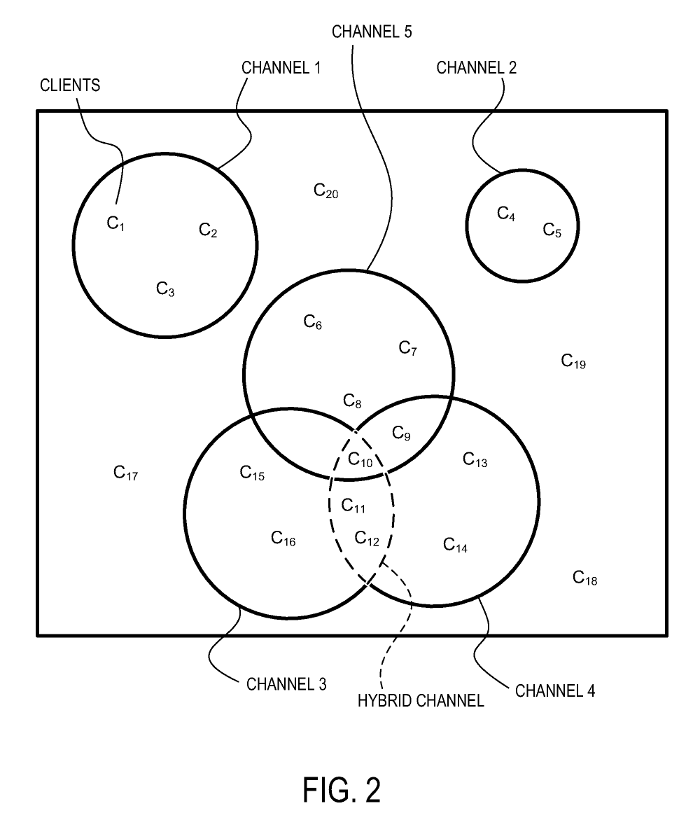

FIG. 2 provides a graphical illustration of the channel mechanism. Multiple clients Cₙ are depicted, with subscripts used to refer to specific clients. The space bounded by the outer rectangle denotes the entire universe of possible client states, where a given client state includes any information of interest pertaining to the client, including demographic, behavioral, contextual and other information. Channels 1-5 are represented by the depicted circles, and represent a specified client state. For example Channel 1 might require clients satisfy an activity profile that includes viewing specific web pages within a set period of time; Channel 2 might specify clients in a particular demographic group that also access a particular search engine more than 10 times a week; etc.

Typically, channel matches in the systems and methods described herein are determined dynamically and regularly updated. For example, FIG. 2 shows channel matches occurring at a particular time. Channel matches typically will change over time. For example, if Channel 3 were to specify clients that had visited any yahoo.com page within the last 5 page views, the user population satisfying that channel would constantly be changing.

It will also be appreciated from the figure that channels may be combined in a variety of ways to create new channels and/or create conditions under which clients are identified as having satisfied a particular profile. For example, clients C₁₀, C₁₁ and C₁₂ are active within both Channels 3 and 4; Clients C₁₅ and C₁₆ are active in Channel 3 but not active in Channel 4; Client C₁₀ is the only client active in all three of Channels 3, 4 and 5; Clients C₁ through C₅ comprise the set of clients that satisfy either of Channels 1 and 2; etc. It should be readily appreciated from this that existing conditions and channel definitions may be combined in various ways (e.g., through logical operators AND, OR, etc.) to greatly increase the ability to target specific client activity.

Privacy considerations will often affect the extent to which a user may be monitored and identified. In targeted advertising systems, for example, identifying users that match behavior profiles will not necessarily mean that the users can be specifically identified with personal information. Rather, identification may mean that the user is internally identified by monitoring processes running within or in connection with the ISP, and that the advertiser is only given the opportunity to provide a specific advert or marketing impression to the user. Also, as described in more detail below, client users may be provided the opportunity to opt-in or opt-out to various levels of participation. For example, various incentives may be provided to encourage users to participate at a higher level and thereby voluntarily lessen privacy protections.

Continuing more generally with the statelessness discussion and examples, the activity profile and channel model discussed herein may be employed in various ways to change the way users experience the Internet:
Advertising and marketing can be dependent upon user states;
Content delivered to a client can be modified based on specific state of the client. For example, the content of internet protocol television (IPTV) can be adjusted in response to the client's state;
Various network security features may be made dependent upon client states;
Internet searching can be enhanced so as to be dependent upon user states/channel matches. For example, search results can be ordered/prioritized to reflect a client's preferred websites, as inferred from monitored browsing behavior;
Channel definitions and user states can be employed to conduct market research; for example a first channel can be defined to identify users whose web activity can be used to infer they have purchased, or will soon purchase a particular type of product. Sub-channels can then be employed subsequently to learn more about the web behavior or preferences of the user group identified by the primary channel;
Channel definitions and user states can be employed for social networking applications and on-line communities, for example by identifying like-minded client users and offering opportunities for them to interact;
User search functionality may be provided, where a search is performed by channels or keywords. In this fashion, the described systems may work as a search engine for people engaging in certain web behavior;
Auto profile matching may be provided, based on matching/non-matching channels in profile A and profile B as a user browses the Internet; the matching may be presented as a browser plug-in, expandable page banner, or a button/actuator on a web page that allows a user to connect with other people interested in specified areas;
Channel definitions and user states may be used to facilitate micro-payments for digital content, e.g., through direct charges to ISP billing statement, and or to achieve identity verification/authentication using an ISP as a trusted intermediary;
Channel definitions and user states may be used to conduct market research, such as to identify brand/subject popularity and dynamics over time; and
Channel definitions and user states may be used to optimize website presentation and enable anti-phishing and parental/content control functionality.

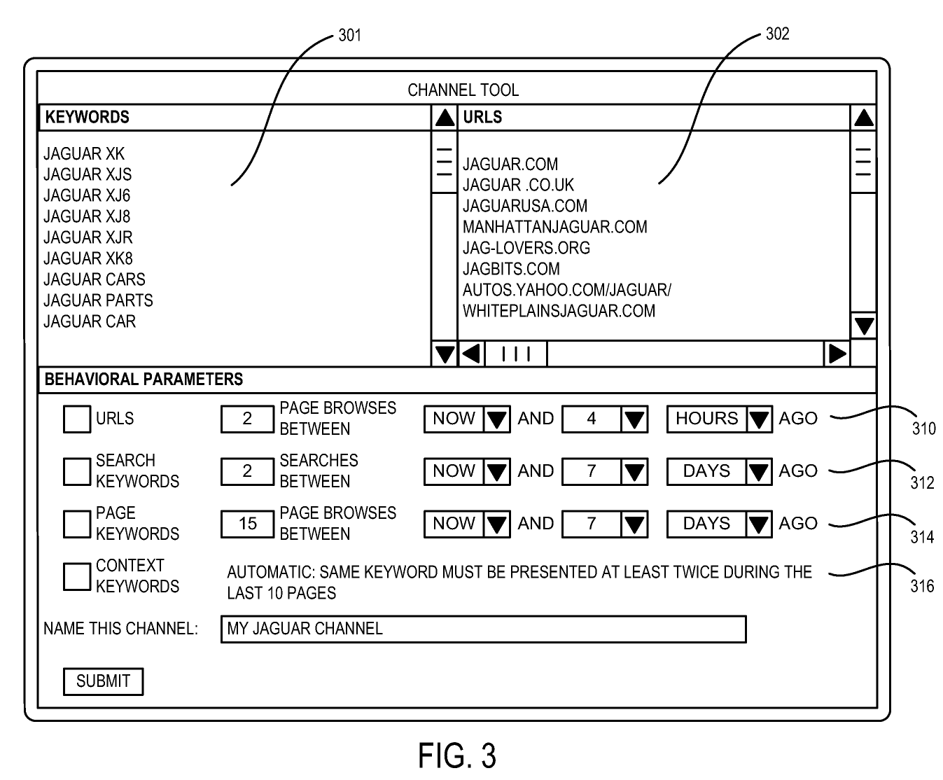

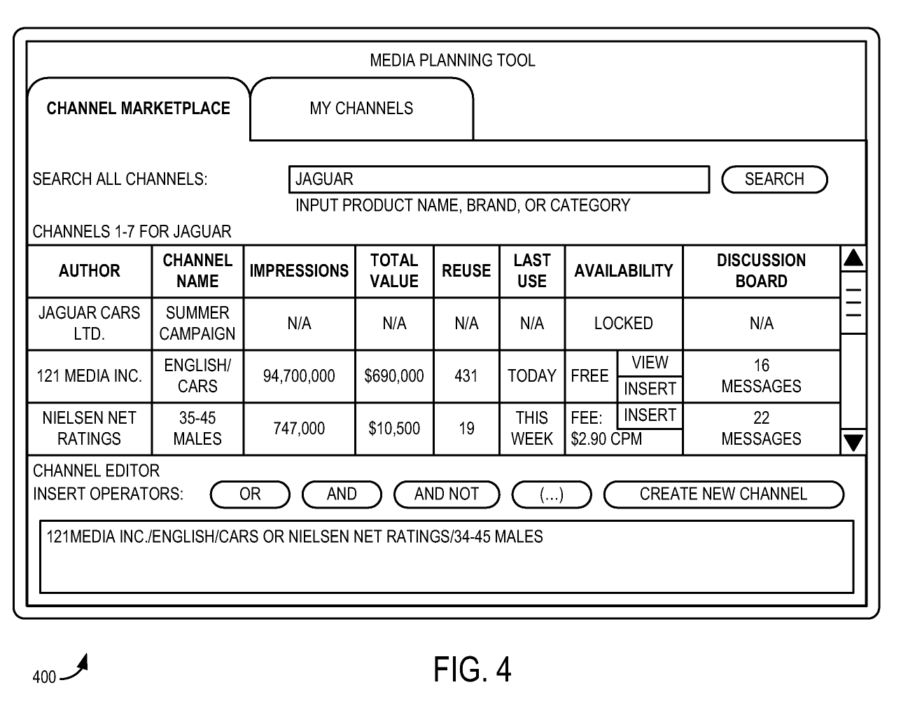

Channel administrator 140 typically is configured to enable an administrative user (e.g., such as an advertiser interested in presenting marketing impressions to likely customers) to establish channels. FIGS. 3 and 4 depict aspects of an exemplary user interface 142 that may be used to perform channel related tasks. As indicated above, creation of channels involves defining Internet behavior of interest. The ability to specify behavioral details in a channel definition depends upon the underlying capabilities of the monitoring software and hardware. In other words, it typically will not be desirable or useful to specify behavioral traits that cannot be detected via the ISP monitoring functions described herein.

Turning specifically to FIG. 3, various examples are provided showing how the interface may be used to set profiles, triggering conditions, etc. that cause a user to be grouped into one or more channels. In some cases, the profiles, conditions, etc. will be referred to herein as behavioral search parameters, since they commonly pertain to and are triggered by specified client Internet activity. As indicated in the example of FIG. 3, two parameters that are often used are URLs visited (shown generally at 302) and keywords present on viewed pages (shown at 301).

For the URLs listed at 302, the channel editor may include a user setting 310 that enables the user to specify the number of visits and/or the frequency of visits to the listed URLs in order for the behavioral condition to be satisfied. In the specific example, the setting has been adjusted to trigger if two or more page views have occurred in the last four hours. Similarly, the channel editor may also include settings 312 and 314 to specify user behavior in terms of the number of keywords encountered or searched by the user and/or the frequency of those encounters/searches. Specifically, in the example at least two searches must be conducted using the listed keywords in the past seven days for the search condition to trigger; for the keyword view trigger, the keywords must have appeared during at least 15 page views over the last seven days. Furthermore, the exemplary channel editor in the figure also includes a setting 316 that requires the same keyword to be present at least twice during the last 10 page views. It will also be appreciated that the depicted time ranges in FIG. 3 may be selected so that a given action (page view, keyword occurrence, etc.) occur between “NOW” and “NOW,” which effectively results in the channel only being active (i.e., satisfied) while the actual page is being viewed, or while the keyword is encountered.

Furthermore, the timing constraints may be used by a publisher to expand its advertising reach and position ads or content close in proximity to when a user encounters the publisher's site. For example, if publisher A has already oversold advertising space on its website “www.publisher-a.com”, the publisher could set up a channel that targets its own website and causes advertising content to be delivered to site visitors after they have left “www.publisher-a.com” (e.g., on a third-party site or via an interstitial ad).

It will be understood that the channel editor described above and with respect to FIG. 3 is but one of many potential examples. As indicated above, time constraints on the parameters may be adjusted to any relevant time period. Conditions may be applied to individual keywords or keyword groupings, rather than the entire keyword or URL listings shown at 302 and 301. Boolean and other logical operators may be used to combine conditions for greater flexibility. A great many other examples are possible.

In addition to the described channel editing functions, the channel administrator 140 may be used to provide access to existing channels and channels owned/created by other users. Channels may be viewed, edited and generally made available for use by others in order to individually and collectively improve the efficiency of web interactions. As with other information/knowledge products, channels made be made available on an open-source basis, or licensed/sold in accordance with specified usage terms. Accordingly, further exemplary aspects of the present description are directed to systems and methods for creating and facilitating a market for the channels described herein. These channel markets will be described in more detail below.

Further aspects of channel creation and deployment may be understood in the context of delivering targeted advertising material based on monitored client activity. In particular, FIG. 4 depicts an implementation of user interface 142 which will be referred to herein as Media Planning Tool 400. The Media Planning Tool forms part of a system that is adapted to coordinate delivery of targeted advertising content based on user states, using the channel mechanism discussed herein.

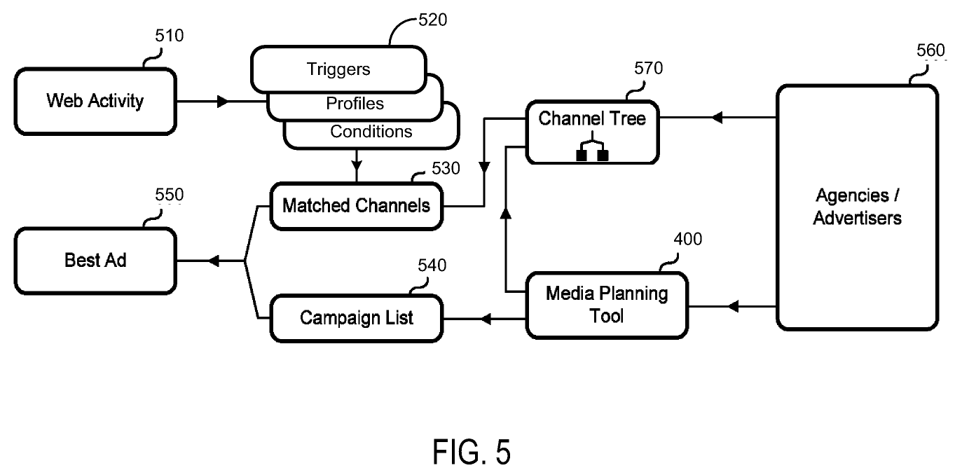

Exemplary data flows which may be employed in the targeted advertising system are shown in FIG. 5. Information concerning client network activity may be generated using the ISP-coordinated monitoring processes described herein. The web activity information received by the monitor and channel server may be sufficient to trigger the activation of one or more channels, which may cause content to be delivered to client 510. In this way, contextual and/or behavioral information may be continually updated as received from the client in response to that client's network activity.

Returning to FIG. 5, advertisers 560 may select and/or create channels via Media Planning Tool 400 including triggers that can be activated by contextual and/or behavioral information received from the client. Various terms are used herein to describe the “state” of a client, including triggers, activity profiles, conditions, etc. These state descriptions 520 can overlap to some extent, but in any case they typically are used as building blocks that can be combined in various ways to form a channel definition.

As will be described in greater detail, the universe of possible client states may be mapped onto a “channel tree” (shown at 570 in FIG. 5) which represents the various available channels (and associated ad campaigns) that may be utilized by advertisers when targeting clients. In one example, a channel is activated by monitored web activity (e.g., by an ISP channel server 128 cross-referencing state descriptions 520 with stored channels 570 to identify one or more matched channels 530). The campaigns associated with the matched channels may then be obtained from campaign list 540, and then a final selection may be performed to initiate delivery of the best ad 550 to the client.

By recording channel matches over time, the system can build up both session behavior and longer-term history for a particular client or set of clients. Further, by cross-referencing with third party data, providers such as Nielsen, Comscore via Media Metrix, online surveys, etc., the approaches described herein may also provide demographic profiles and groups. The contextual and/or behavioral information of one or more clients may be combined with a range of available campaigns and their corresponding rates and performance to provide the highest-yielding advertisement to the client user based on their behavior or who they are (e.g. demographic), what they have done (e.g. session and history), and/or where they are now (e.g. contextual).

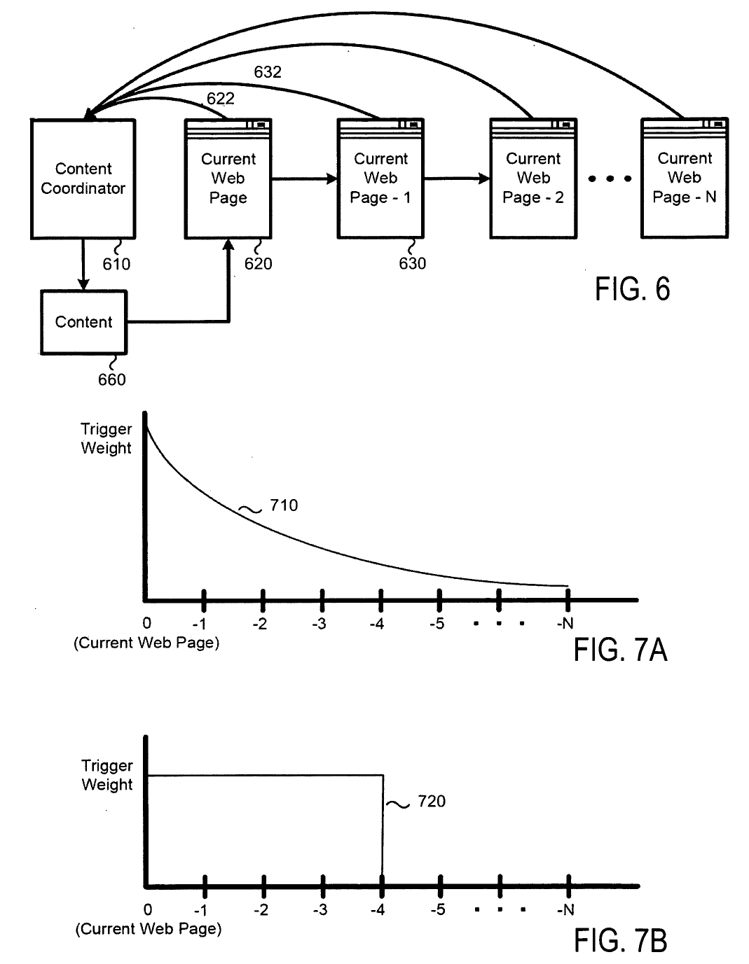

Establishing conditions, profiles, triggers, etc. to build channels is further illustrated in FIGS. 6, 7A and 7B, which expand upon and extend the channel-building discussion introduced with FIG. 3. FIG. 6 provides a schematic illustration explaining an example of how the system selects appropriate targeted content. As one example, a channel server 610 can utilize contextual information associated with the present or current web page to activate triggers as indicated by 622. The content coordinator may utilize contextual and/or behavioral information associated with a previous web page such as at 630, as shown by 632. Similarly, contextual and/or behavioral information associated with even older or previous web pages may be considered by the content coordinator for selecting content to be delivered to the current web page.

Further, in some embodiments, the content coordinator may adjust the weighting of the contextual and/or behavioral information based on the temporal location of their respective web page. FIGS. 7A and 7B illustrate non-limiting examples of how the weighting of contextual and/or behavioral information may be varied in response to the historical context of their originating web page. For example, FIG. 7A illustrates how contextual and/or behavioral information associated with more recent web pages may be more influential to the content coordinator as compared to contextual and/or behavioral information associated with less recent web pages. In other words, contextual and/or behavioral information such as keywords or other information associated with the webpage more recently received by the client may have greater effect on the decision process than the keywords associated with a prior web page. As illustrated by FIG. 7B, contextual and/or behavioral information associated with two or more web pages may be given equal weighting up until a particular threshold (e.g. the 3 or 4 previous web page views). For example, contextual and/or behavioral information associated with the current web page and the three prior web pages may be utilized by the content coordinator while triggers associated with web pages occurring even earlier may be omitted or provide less influence toward the selection of content. While FIGS. 7A and 7B provide example weighting functions 710 and 720 respectively, it should be appreciated that any suitable function may be used to control the selection of content. Further still, these weighting functions may be adapted or optimized based on parameters set by the advertiser or content provider to further enhance the tailored content that is delivered to the client.

Media Planning Tool 400 typically is integrated with channel administrator 140 (FIG. 1) or forms part of a suite of software tools that includes the administrator module. The Media Planning Tool can be used to enable one or more advertisers, ISPs, publishers, etc. to control delivery of content associated with advertising campaigns in an effective, targeted way that is based on observed web behavior of potential advertising targets. Note that the term advertiser as used herein, may include publishers, advertisers, ad agencies, companies, ISPs, content providers, moderators, etc.

As one example, channels may be selected from a repository or database (e.g., accessible from central channel server group 160) via Media Planning Tool 400 and/or channels may be shared among two or more advertisers. In some embodiments, the system may encompass an electronic marketplace accessible from and facilitated by the Media Planning Tool interface, to enable advertisers, publishers, ISPs, moderators, etc. to share ratings and discussions regarding content targeting and channel configuration or construction. This market may also allow channels to be viewed, sold or licensed on a fee basis, where the Media Planning Tool provides the front-end user interface for conducting the transaction.

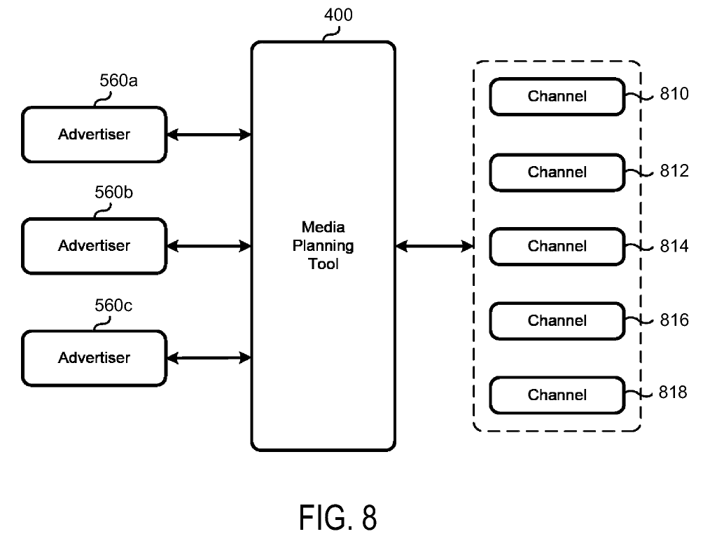

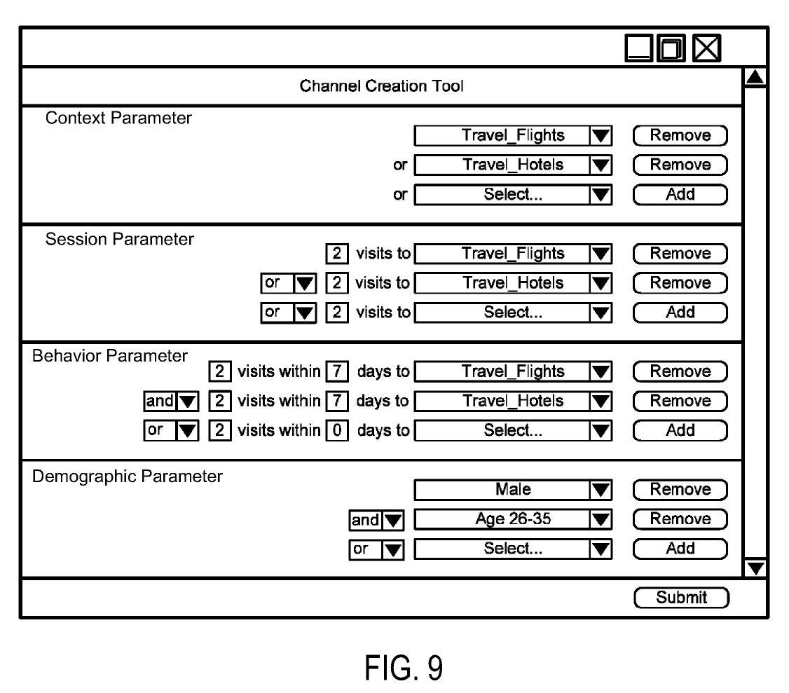

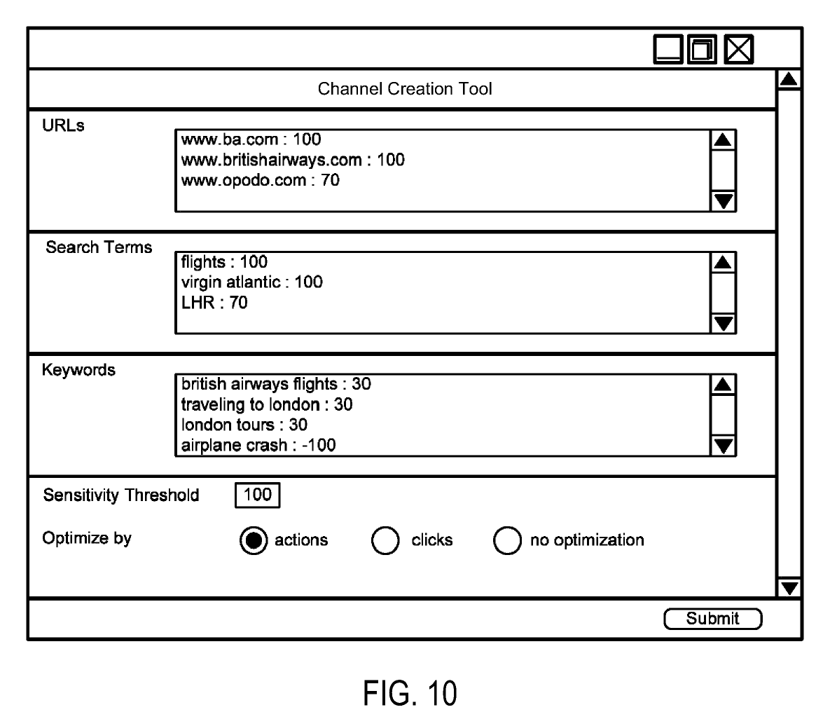

FIG. 8 illustrates several example scenarios to explain how an advertiser may select, create, modify and share an advertising channel via the Media Planning Tool. As shown, advertisers 560 may access and/or share channels 810, 812, 814, 816, and 818 via Media Planning Tool 400. In this particular scenario, channel 810 includes a public or “open source” channel that may be shared between two or more advertisers via the market facilitated by the Media Planning Tool. For example, a first advertiser 560 may have created channel 810 with the Media Planning Tool as will be described in greater detail with reference to FIGS. 9 and 10, whereby the channel was shared as a public (open) channel with one or both of the other advertisers 560 depicted in FIG. 8. In other words, any of the depicted advertisers may be able to access and/or use channels created by other advertisers, or alternatively modify those channels, to suit their particular needs, depending upon the usage terms specified by the channel owner.

For example, advertiser 560a can modify channel 810 to create channel 812. Further, advertiser 560a may specify usage terms of channel 812, so that the channel is open (viewable and useable by others without a fee) or available for a fee and/or at other terms. For example, where channel 812 has been set as a private channel, advertiser 560a may limit access to channel 812 to specific advertisers that they select. As one example, advertiser 560a may sell or license channel 812 to another advertiser, such as advertiser 560c, while withholding access to the channel from advertiser 560b.

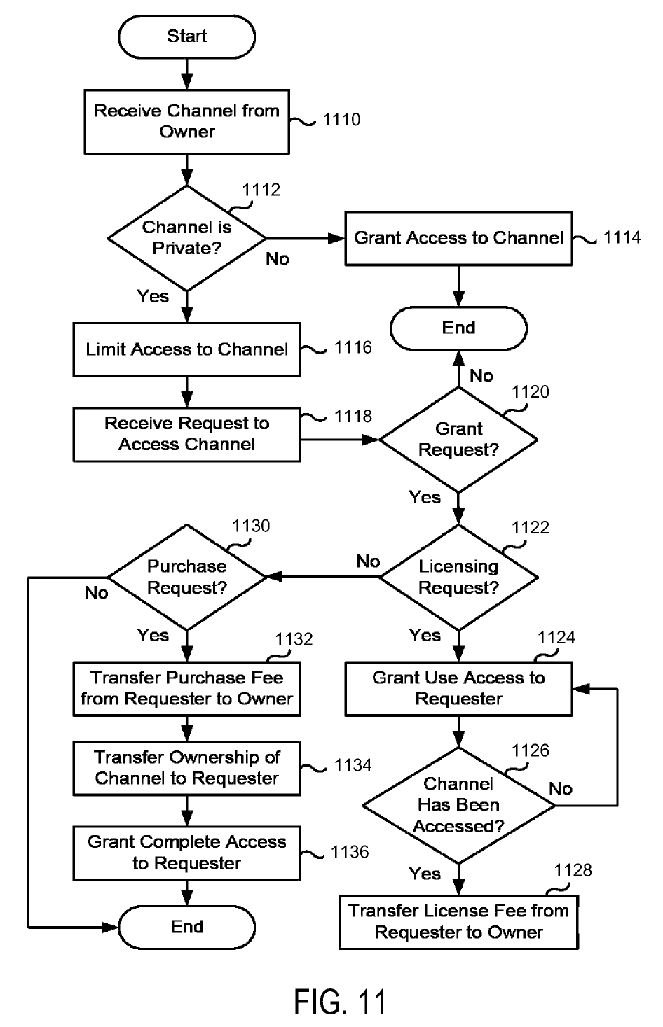

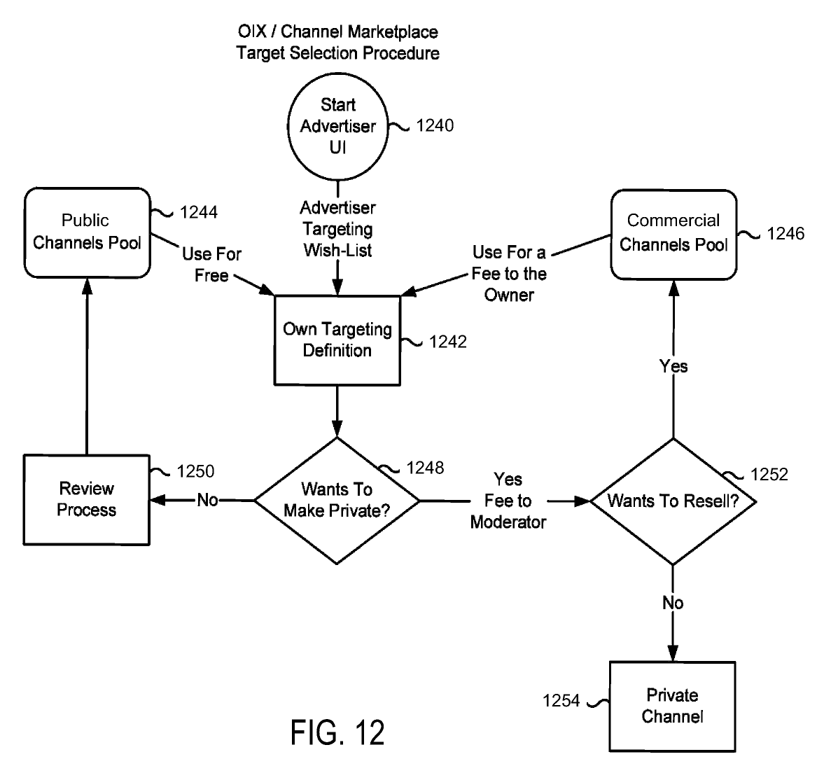

In this way, an advertiser can select, create, modify, and/or share a channel; select whether the channel is to be public or private; and receive revenue from the licensing or sale of their private channels. The Media Planning Tool can enable some or all of these features as well as facilitating the transfer of monetary funds from one advertiser to another with regards to the licensing or purchase of channels. Note that a party such as a moderator, ISP, publisher, or other suitable party can host the Media Planning Tool and facilitate the interaction of other parties relating to the various channel functions such as will be described in greater detail with reference to FIGS. 11 and 12. As one non-limiting example, a moderator can host the Media Planning Tool as an independent party, whereby equal access to the media planning to can be granted by the moderator to a plurality of various different parties or even the general public.

FIGS. 9 and 10 illustrate example tools that may be used by an advertiser to select, create, or modify a channel. These examples overlap in many respects with the channel generation examples discussed above, though the present examples are directed more specifically to targeted advertising. As one example, the Media Planning Tool may include a software application that provides the advertiser with the ability to control the channels applied to particular advertising campaigns. While the menus illustrated in FIGS. 9 and 10 provide a specific example of an interface of the Media Planning Tool, it should be appreciated that these examples are non-limiting and that other examples and embodiments are possible. Note also that multiple parties can utilize the Media Planning Tool to control the same campaign, thereby enabling collaboration among advertisers, publishers, ISPs, moderators, etc.

FIG. 9 illustrates a channel creation tool that can be used to create or modify one or more channels. In this particular example, an advertiser may seek to create a channel relating to airline travel. However, it should be appreciated that other parameters relating to various categories or sub-categories may be created. For example, channels relating to a sports themed category may be created including sub-categories or parameters such as baseball, football, soccer. As another example, channels relating to an automotive themed category may be created including sub-categories such as racing, repair, reviews, etc. These channels may include various triggers associated with different categories and sub-categories, an example of which is illustrated in FIG. 9.

In particular, the example of FIG. 9 shows the ability to modify the channel definition through control of one or more parameters. The creation of a channel or set of channels mapped onto a channel tree may include the selection of one or more context parameters. For example, the context parameter “Travel_Flights” selected from the pull down menu may be matched to clients that have retrieved web pages including information relating to travel or airline flights. Similarly, the context parameter “Travel_Hotels” which has also been selected from the pull down menu may match clients that have retrieved web pages including information relating to travel or hotel stay. In this manner, any number of context parameters may be added, where in this case two have been provided: “Travel_Flights” and “Travel_Hotels”. As will be described in greater detail with reference to FIG. 10, these context parameters may be created or modified to include any number or type of observable information. For example, the “Travel_Flights” context parameter may be satisfied through client page views including keywords such as “flights”, “travel”, “tickets”, “airline”, etc.

The session parameters can be used to qualify the user visit a specified web page a specified number of times within the browser session or login session. For example, as illustrated in FIG. 9, session parameters may be triggered by client users who have visited 2 or more web pages associated with “Travel_Flights,” “Travel_Hotels,” etc. It should be appreciated that any suitable number of visits may be entered. In this manner an advertiser may select a frequency threshold at which the client's activity will correlate with a particular channel or parameter.

Note that various logic operators may be selected to enable further control over the channels and hence the delivery of tailored content. As illustrated by the example of FIG. 9, a pull-down menu can used to select logic operators such as OR and AND. These are but examples-any suitable logic operator or other condition-defining mechanism may be used to control the creation of the channel and its inclusion in the channel tree.

As illustrated in FIG. 9, the OR logic operator has been selected for joining the two selected conditions of the session parameters. As such, clients that have retrieved 2 or more web pages associated with the “Travel_Flights” or the “Travel_Hotels” context parameters will be evaluated as a match by the content coordinator/channel server. Alternatively, the AND operator may be selected so that clients may be matched where they have retrieved 2 or more web pages associated with both the “Travel_Flights” and the “Travel_Hotels” context parameters.

In a similar manner, the advertising channels can be controlled to qualify the channel based on the client's frequency of receiving content associated with the context channels. As one example, as illustrated in FIG. 9, the channel may be matched to the client where the client has retrieved at least 2 web pages associated with the “Travel_Flights” channel within the past 7 days and (as prescribed by the logic operator) where the client has also retrieved at least 2 web pages associated with the “Travel_Hotels” channel within the past 7 days. It should be appreciated that these conditions may be adjusted by the advertiser, for example, by changing the logic operator from an “and” to an “or”, or other suitable operator. Further, the conditions assigned to the behavioral channel such as the number of visits or number of days may be adjusted to achieve different client/content matching.

Similarly, demographic parameters may be adjusted. Demographic parameters may be adjusted to reflect a particular demographic group such as age, sex, socioeconomic status, among others, against which a client may qualify. For example, as illustrated in FIG. 9, a first demographic parameter may include male/female selection, while a second parameter may allow selection of an age range (e.g. 26-35). In this way, a client user fitting the demographic parameters may be matched to content effective or suitable to their particular group. These demographic groups may be created by the advertiser or other party from market research information (e.g. Nielsen or Comscore) or may be created by third party data specialists on behalf of the advertiser utilizing the collaborative environment provided by the Media Planning Tool. As yet another example, the demographic parameters may be augmented and validated by online surveys directed to the client users. The various demographic parameters can be presented as channels. For example, a channel may include the demographic parameter of client users that are between the ages of 26 and 35 years old.

It should be appreciated that any suitable number or type of channel creation tools may be used, including, but not limited to the features shown in FIG. 9 for specifying context, session, behavioral and demographic parameters. Any one of these parameters can be added or removed from the channel by selecting the corresponding “remove ” or “add” icons. Once a channel has been constructed as desired, the “Submit” icon may be used to load the channel into the system for distribution to the various channel servers (e.g., a channel server 128 operating within an ISP).

FIG. 10 depicts further features that may be used to adjust/specify triggers, conditions etc. of a channel. In particular, the depicted example allows the assigning of values to the parameters discussed with reference to FIG. 9. Continuing with the airline travel example, in the “URLs” field, one or more URLs of interest may be weighted to control the influence of those URLs over the channel matching operation performed at the channel servers. As illustrated in FIG. 10, the URL “www.ba.com” has been selected and assigned a value of 100, while “www.opodo.com” has been be selected and assigned a lesser value of 70. In other words, clients requesting the URL address “www.ba.com” may be matched to the particular channel by activating the trigger whereas clients requesting “www.opodo.com”, under at least some conditions, may not be matched.

In some embodiments, a sensitivity threshold may be assigned that designates the minimum value for a particular advertisement to be served to the client. The sensitivity threshold can be useful where the advertiser or other party desires that more than one trigger or combination of triggers are present before the channel is matched. For example, if the keyword value is 30 and the threshold is assigned to 100, then a minimum of 4 keywords will be necessary for the channel to be matched to the client. By increasing the sensitivity threshold, the specificity of the match may be increased, which may serve to increase the effectiveness of the content (e.g. advertisement) while reducing the number of matches and hence quantity of advertisements served. Conversely, reducing the sensitivity threshold may result in more matches and therefore a greater number of advertisements that are served. However, by decreasing the sensitivity threshold, the match may also become shallower, and the advertisements potentially less effective. As illustrated in FIG. 10, the sensitivity threshold has been set to “100”. Thus, a client requesting a URL address associated with “www.ba.com” may be matched (e.g. served a particular advertisement) since the value of the particular URL is equal to or greater than the sensitivity threshold. In contrast, the same client requesting “www.opodo.com” may not receive the same advertisement since the value of 70 is less than the sensitivity threshold of 100.

As further shown in FIG. 10, weighting may be applied to other parameters. For example, the “Search Terms” field includes the search term “flights” having an assigned value of 100. When a user searches for the term “flights” (e.g. via a web based search engine), the client may be matched to the channel and receive a corresponding advertisement since the assigned valve is equal to or greater than the assigned sensitivity threshold. Similarly, keywords on a web page may be selected and assigned a corresponding value via the “Keywords” field. For example, the keyword “London tours” has been added with an assigned value of 30. In the condition where a single keyword is located on a web page, a client may not be matched due to the value of 30 being less than the sensitivity threshold. In other words, other contextual and/or behavioral information may be required in this scenario for the trigger to be activated and for the channel to be matched to the client.

Further, contextual and/or behavioral information may be assigned negative values that can be deducted from the total value created by the other contextual and/or behavioral information. For example, the keyword “airplane crash” has been assigned a negative value of “−100”. Thus, where the client has search for the term “flights” which has a value of 100, has visited URL “www.opodo.com” which has a value of 70, and the web page includes the keyword “airplane crash” which has a value of “−100”, the client may not be matched to the channel since the summation of these three values are less than the sensitivity threshold of 100. In this manner, the match strength or total value for a particular web page may include the summation of the contextual and/or behavioral information selected with the channel selection tool. Further, it should be appreciated that these values may be modified by a weighting function as described above with reference to FIGS. 7A and 7B. For example, the values illustrated in FIG. 10 may represent the maximum value associated with the contextual and/or behavioral information, whereby the value is reduced as the web page associated with the contextual and/or behavioral information has been retrieved less recently by the client.

In some embodiments, the examples just discussed can enable the advertiser to create a list of banned contextual information that prevents the trigger from being activated and from the client being matched to the channel. For example, the keyword “airplane crash” may be assigned as banned contextual information that precludes the trigger from activating where the user has requested information including the keyword “airplane crash”. In this manner, an advertisement associated with the channel will not be displayed to the user and instead a default advertisement, if any, may be provided.

The reader will recognize that the interface examples herein provide an operator with limitless possibilities for channel creation and related parameters.

In this way, the Media Planning Tool enables an advertiser to select, create, and/or modify channels. As such, it is possible for an advertiser to reach a desired audience or set of client users based on who they are (e.g. the demographic), what they have been doing (e.g. the session and behavior), and where they are now (e.g. the current context).

FIG. 11 is a flow chart illustrating an example method of managing channel access among multiple parties. At 1110 the channel may be received from the channel owner. For example, the owner (e.g. advertiser or other party) may submit or create a channel or set of channels that can be used for selecting targeted content. The owner of the channel may select whether the channel is to be public to other parties of the channel sharing community or instead private. For example, if it is judged at 1112 that the channel is to be public, then access to the channel may be granted to other parties at 1114, wherein the channel may be viewed, used, or modified by other parties. Alternatively, if it is judged that the channel is to be instead private, then access to the channel may be limited at 11 16. For example, only the owner of the channel or specific parties that are designated by the channel owner may be able to access the channel, while access may be denied to other parties unless specifically granted by owner.

At 1118, a request to access the private channel may be received from a requesting party where it may be judged whether the requested access should be granted. For example, an advertiser may seek to use a private channel owned by another advertiser. If the owner does not wish to grant access to the requestor, then the routine may end. Alternatively, if access is to be granted, then it may be judged at 1122 whether the request is a licensing request. For example, the channel owner may seek to license the use of their proprietary channel while maintaining the secrecy of the particular channel parameters. If the requester desires to license the use of the channel, then at least some level of access to the channel may be granted at 1124. As one example, a particular level of access may be enabled so that the requester can utilize the channel in their particular advertising campaign. However, for some levels of access, the requester may be unable to identify the particular channel parameters, thereby maintaining the confidentiality of the proprietary channel.

At 1126, it may be judged whether the channel has been accessed (e.g. implemented) by the requester and if so, the appropriate licensing fee may be transferred from the requester to the channel owner as indicated at 1128. For example, the channel license may be structured on a per use basis, time use basis, etc. However, it should be appreciated that other licensing options may be used. Alternatively, if the channel has not been accessed at 1126, the routine may return to 1124 until the channel is accessed or used by the requester.

As an alternative to the licensing request, the requestor may seek to purchase the channel from the owner. In this scenario, it may be judged at 1130 whether the request is a purchase request. If the answer is yes, a corresponding purchasing fee may be transferred from the requester to the owner at 1132 and the ownership of the channel and/or the complete access of the channel may be granted to the requestor. In other words, upon purchase of the channel, the requestor may be granted complete access which enables the requestor as purchaser to view the specific contents or configuration of the channel, to use the channel, to modify the channel, to re-sell the channel, to license the channel to other parties, to exclude other parties from use of the channel, and/or to select whether the channel is to be made public.

Referring now to FIG. 12, a schematic diagram of an open channel market is provided. Note that the approach of FIG. 12 can be used in addition to or as an alternative to the approach described above with reference to FIG. 11. At 1240, an advertiser or other suitable party may initiate a user interface of the Media Planning Tool at 1240 in order to create a content targeting definition (e.g. channel) for their advertising campaign at 1242. As one example, the user interface may include a software application provided by a moderator of the Media Planning Tool. The content targeting definition created at 1242 may be based on one or more public channels received from a public channel pool 1244 or commercial channels (i.e. private channels) received from a commercial channel pool 1246. Note that the public and commercial channel pools can each include one or more channels. For example, the public channel pool may include a collection of channels that have been created and/or have used by other advertisers or third parties. In some embodiments, public channels may be used by the advertiser for free, while commercial channels may be used for a fee. These fees may be paid to the owner of the channel and/or the moderator. In alternative embodiments, use of the public channel may require a fee that is less than the fee for a commercial channel. For example, a smaller public channel fee may be paid by the advertiser to the moderator, while a larger commercial channel fee may be paid to the owner of the channel and/or moderator.

Upon creation of a channel or other suitable targeting definition at 1242, the advertiser creating the channel can select at 1248 whether the channel is to be private or public. If, for example, the channel is selected to be public, a review process may be initiated at 1250, before the public channel is added to the public channel pool at 1244. As one example, the review process may compare the channel to other channels within the pool and eliminate duplicative channels. As another example, the review process may examine the channel and attach identifiers to the channel so that it may be identified from the pool of public channels by other advertisers. As yet another example, the review process may return channels to the advertiser for modification, if there is a defect, before granting submission to the public channel pool. Note that in some embodiments, the moderator may pay a fee to the channel creator for granting public access to the channel at 1248.

If the channel is instead made private at 1248, then access to the channel by other advertisers may be limited or restricted. In some embodiments, a fee may be paid to the moderator by the channel creator in order to select that the channel remains as a private channel. At 1252, the advertiser may select whether the private channel may resold for use by other advertisers. If the answer is no, then the channel may remain private, for example, where it may be used only by the advertiser that created the channel or other parties that the advertiser designates. Alternatively, if the advertiser desires to resell the channel at 1252, then their channel may be added to the commercial channel pool at 1246. Note that in some embodiments, a review process may be applied to the private channel before addition to the commercial channel pool, for example, as described with reference to 1250. Thus, other advertisers may utilize the Media Planning Tool as described above to use the previously created private channel for a fee. Note that information associated with private channels may, under some conditions, be withheld from a third party that is using the channel for a fee so that the confidentiality of the channel contents may be maintained. In this manner, other advertisers may continue paying a fee to the channel owner for subsequent channel uses even after they have initially used the channel.

In this way, a moderator can utilize the Media Planning Tool to facilitate an open market among advertisers for channels. Thus, parties may seek not only to create channels for their own advertising campaigns, but may license or sell their proprietary channels to other advertisers. By maintaining the confidentiality of the channels, the channel owner may derive revenue from their proprietary information and “know-how” via licensing the use of their channels to third parties. Note that the approaches described with reference to FIGS. 11 and 12 may be performed by the Media Planning Tool and facilitated by the moderator or other suitable party.

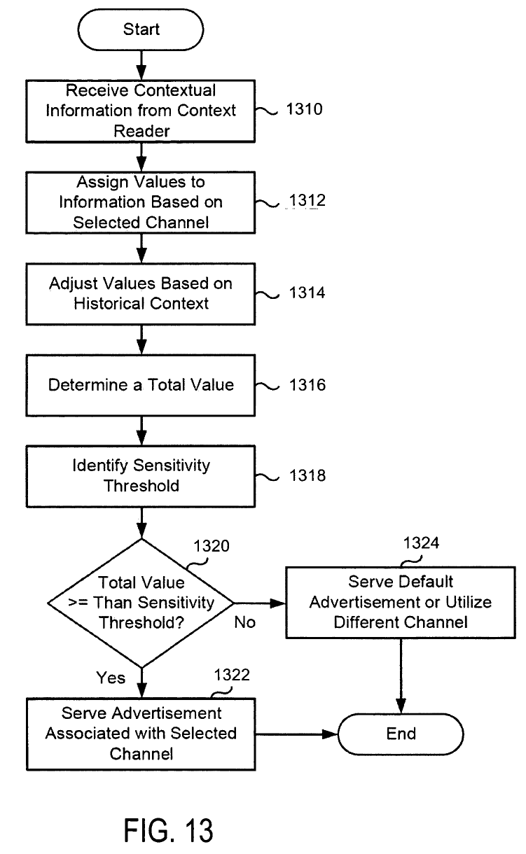

FIG. 13 is a flow chart illustrating an example routine that may be performed to determine whether an advertisement or other content should be delivered to the client. At 1310, contextual and/or behavioral information may be received from or attributed to the client. At 1312, values may be assigned to the contextual and/or behavioral information responsive to the values set by the advertiser, for example, via the channel selection tool described herein.

At 1314, the value of the contextual and/or behavioral information may be adjusted based on their historical context. For example, as described above with reference to FIGS. 7A and 7B, the value of contextual and/or behavioral information may be reduced or alternatively increased based on the relative historical proximity to the current web page or other content retrieved by the client. As one example, the value of a particular keyword located on a web page may decrease (e.g. based on a predefined function) with each successive web page retrieved by the client device after the particular web page where the keyword originated. As another example, contextual and/or behavioral information having negative values may increase in value (e.g. become less negative) as the associated web page becomes less recent.

At 1316, a total value of the contextual and/or behavioral information may be determined based on the assigned and/or adjusted values received from the client's context reader. The sensitivity threshold may be identified at 1318, for example, as set by the advertiser via the channel creation tool of FIG. 10. The total value determined at 1316 may be compared to the sensitivity threshold identified at 1318 determined at 1320 whether the total value is greater than or equal to the sensitivity threshold. If the answer at 1320 is yes, the content (e.g. advertisement) associated with the selected channel may be served to the client at 1322. For example, a link may be transmitted to the client device that is usable to retrieve the advertisement or other content. As another example, the content may be transmitted directly to the client device. Alternatively, if the answer at 1320 is no, default content may be served to the client or a different channel may be utilized. In this way, the approach described with reference to FIG. 13 may be applied to some or all of the channels of the advertiser's campaign. Note that the default advertisement or content may include no content, thereby enabling the publisher or ISP to utilize their own advertisement or content in place of the content provided by the channel server.

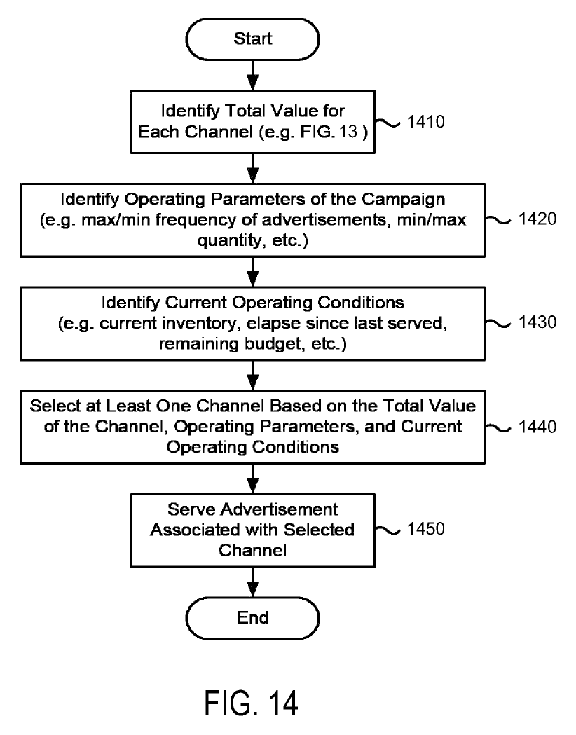

FIG. 14 is a flow chart illustrating an example routine that may be performed (e.g. by the channel server) to identify which channel of a plurality of channels should be selected, whereby the associated advertisement may be delivered to the client. At 1410, the routine may identify a total value for each channel as described, for example, with reference to 1310-1316 of FIG. 13. At 1420, the operating parameters of the campaign may be identified, including, but not limited to the maximum and/or minimum frequencies for the advertisement associated with each channel, the minimum and/or maximum quantity of advertisements to be served as associated with each channel, the minimum and/or maximum duration between the serving of advertisements associated with each channel, etc. Note that these parameters may be set by the advertiser via the Media Planning Tool.

Returning briefly to FIG. 5, the channels selected, created, licensed, or modified by the advertiser may be configured as a channel tree as indicated at 570. As illustrated, the advertiser may vary the channels (e.g. the behavioral channels 572, the demographic channels 574, etc.) associated with the channel tree. The Media Planning Tool can also enable advertisers to define the parameters of the advertising campaigns as indicated at 540. The matched channels 530 are used to select content to be delivered to the client based on the campaign list 540 as prescribed by the advertiser.

The Media Planning Tool gives the advertiser the ability to run, extend, modify or renew campaigns that have been previously created. The Media Planning Tool also enables the advertiser to achieve one or more of the following: upload creatives, define insertion orders and campaigns, set frequency limits for the serving of advertisements, select channels to run, set or identify the cost per click (CPC), cost per mille (CPM) or cost per action (CPA) to be paid, set geo-targeting, set time-of-day and day-of-week parameters for the serving of advertisements, set the duration (e.g. start and finish) of the campaign, set campaign goals (e.g. impressions, clicks, etc.). Furthermore, the CPM, CPC, and CPA can be used for campaigns and channels, and can be used in combinations that can be user-defined. For example, a combination of CPM+CPA may be used whereby someone pays for impression and additionally for every action. These and other parameters may be identified at 1420. From this discussion, it should be apparent that the present systems may be employed to combine metrics in various ways, and/or to create new metrics, to dramatically increase information granularity and improve the delivery of advertising.

At 1430, the current operating conditions may be identified including the current inventory of advertisements served to some or all of the clients, elapsed time or number of page views since the advertisement was last served, the remaining advertising budget, etc. At 1440, at least one channel may be selected from the plurality of channels applied to the campaign (e.g. via the channel tree) based on one or more of the total value of each of the channels identified at 1410, the campaign operating parameters, and the current operating conditions. At 1450, the advertisement associated with the selected channel may be served to the client. While the above example has been described with reference to advertising content, other content may be served to the client using a similar approach.

In some embodiments, the Media Planning Tool can be used to provide the advertiser with estimates of the number of advertisements that may be served based on their particular channels and campaign parameters. As a first approach, a campaign that has already been performed and is being renewed or is similar to an existing campaign, an inventory estimation (e.g. prediction of goal performance) can be made available to the advertiser.

As a second approach, a campaign can be set to a virtual mode where the campaign is simulated by running it across the system to estimate its performance. For example, the virtual campaigns can be compared to other live campaigns utilizing a strategy similar to that described above with reference to FIGS. 13 and 14. The virtual mode can provide the advertiser with a realistic prediction of the number of advertisements served since the virtual advertisements compete with other live campaigns, using live client behavior, real frequency caps, and eCPM prioritization. As one example, the Media Planning Tool may include an eCPM prioritization model that seeks to increase return on investment for the advertiser for direct response campaigns. Further, campaign performance information, such as clicks and actions, may be fed back into the channel tree to optimize the channels, enabling other campaigns to benefit. The optimization may be applied to channels that are public or channels that are private and can be licensed without displaying their content. The duration of the simulation may be as short as a few minutes, depending on the specificity of the targeting (e.g. channel configuration) and the level of statistical significance desired.

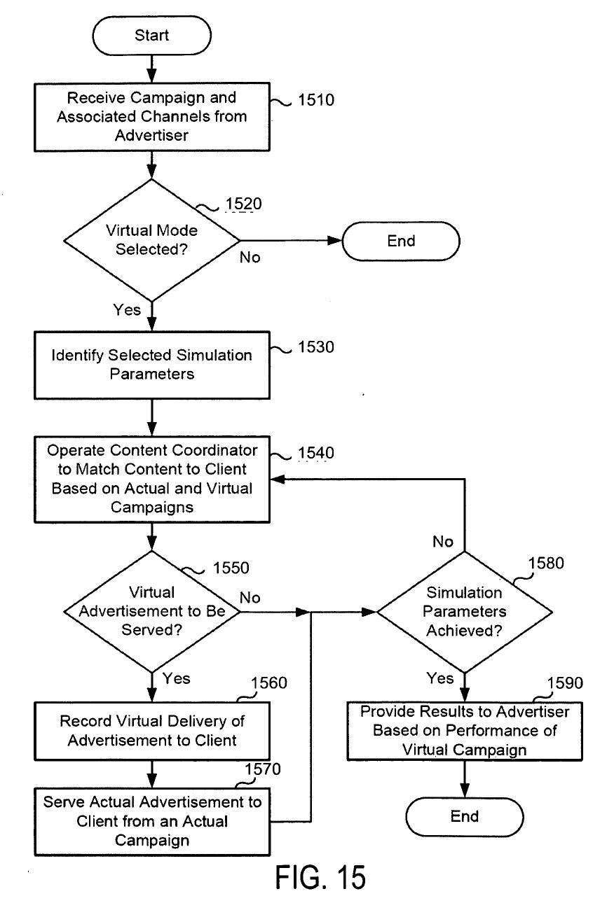

FIG. 15 is a flow chart illustrating an example simulation that may be facilitated by the Media Planning Tool. At 1510, the campaign and associated channels may be received by the Media Planning Tool. For example, an advertiser can create a new campaign including one or more channels for enabling the targeting of content to particular clients. At 1520, it may be judged whether the virtual mode has been selected by the advertiser. If the answer is no, the routine ends.

Alternatively, if the answer at 1520 is yes, the simulation parameters may be identified at 1530. For example, the advertiser may prescribe the duration of the simulation, statistical confidence for termination of the simulation, or other suitable simulation parameters. At 1540, the simulation may be initiated where the channel is used to select content for delivery to clients. The virtual campaign including one or more channels can compete with live campaigns.

At 1550, it may be judged whether the virtual advertisement or content is to be served. For example, as the channels associated with the virtual campaign are compared to the client's contextual and/or behavioral information along with channels associated with the actual or live campaigns, the virtual advertisement associated with the virtual campaign may be selected over advertisements associated with live campaigns. Therefore, if it is judged that the virtual advertisement is to be served to the client (e.g. the virtual channels were matched) then the simulated delivery of the virtual advertisement to the client may be recorded at 1560 and an actual advertisement associated with the next best matching channel from a live campaign may be actually delivered to the client at 1570.

Alternatively, if the answer at 1550 is no or from 1570, it may be judged whether the simulation parameters have been achieved. For example, if the simulation parameters have been set to provide at least a prescribed amount of data, then the route may judge whether the prescribed amount of data has been provided by the simulation. If the answer is no, the routine may return to 1540 where the virtual campaign continues to compete with live campaigns for the selection of advertising content or other suitable content. Alternatively, if the answer at 1580 is yes, then the results of the simulation may be provided to the advertiser or other party initiating the simulation. For example, the performance of the virtual campaign including the simulated delivery of virtual content via 1560 may be provided to the advertiser. In this manner, a campaign may be simulated in an actual competitive setting prior to setting the campaign to a live setting and actually running the campaign. If, for example, the advertiser is dissatisfied with the performance of their campaign in the virtual mode, the advertiser can modify the campaign or utilize a different campaign including the same or different channels to achieve a more desirable performance. Simulation may also help advertisers estimate the necessary advertising campaign budget, and/or control the rate at which the budgeted funds are expended.

Further, the Media Planning Tool also can be configured to provide reporting to the advertiser. As one example, the Media Planning Tool can provide performance reporting on the basis of campaign goals such as impressions, reach, clicks, actions, etc. It may be fully integrated with third party advertising systems such as DART and ATLAS, and can provide advanced metrics for video and bridge advertisements displayed to a client between domain navigations or between television programming.

The Media Planning Tool can provide ISP specific controls. As one example, the ISP can choose to show bridge advertisements in addition to augmenting the performance of in-page advertisements shown by participating publishers. For bridge advertisements, the ISP may be provided the ability to control the delay before showing of the first bridge advertisement in a login session, the minimum time between bridge advertisements being shown, and/or the maximum number of bridge advertisements shown per client per day. Still other factors may be controlled. Thus, an ISP may be provided additional control over campaigns run through their system independent of the advertiser.

Publishers and ISPs who utilize bridge advertisements provide a location where advertising can be shown. As owners of that space, they can specify the type of advertising that they do not wish to show by utilizing the Media Planning Tool. Similarly, they may review and/or veto actual advertisements that are run by the advertiser. As one example, publishers or ISPs can wrap existing advertising tags with an additional tag and specify an eCPM or price threshold for it. If the channel server can identify an advertisement of higher value than the threshold, the higher value advertisement may be shown. Otherwise, the original advertisement may be served to the client.

In some embodiments, content coordination may be selectively performed based on client preference. In particular, the content coordination system may provide a client with one or more opportunities to choose whether or not to participate in content coordination. By choosing to participate in content coordination, a client may receive targeted content based on anonymous contextual and/or behavioral information acquired during client network activity. Whereas, by choosing not to participate in content coordination, the client may receive untargeted content and anonymous contextual and/or behavioral information is not acquired during client network activity. The client participation request for content coordination may be generated in different forms based on various events.

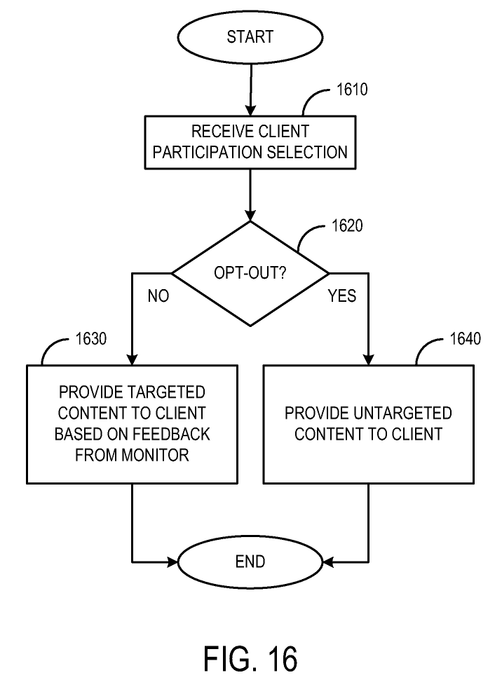

FIG. 16 shows a flow chart depicting an example routine for enabling a client to select whether they opt-out of receiving targeted content in response to their network activity as obtained by a monitor or whether they instead opt-out of receiving the targeted content. At 1610, the client participation may be received at the moderator or ISP in response to a prompt, for example. If at 1620, the client response included an opt-out selection, then targeted content can be provided to the client in response to feedback provided by the monitor. For example, the behavioral information obtained from the client's interaction with the network may be used to select targeted content based on one or more channels. Alternatively, if the client response included an opt-out selection, then untargeted content may be provided to the client, by the moderator or another party, which is not based on feedback from the monitor. In this way, the client may be permitted to control whether they receive targeted content or untargeted content.

In some examples, the default selection may be set to an opt-in setting, whereby the user can select whether they would like to opt-out to receive untargeted content. In other examples, the default selection may be set to an opt-out setting, whereby the user can select whether they would like to opt-in to receive targeted content.

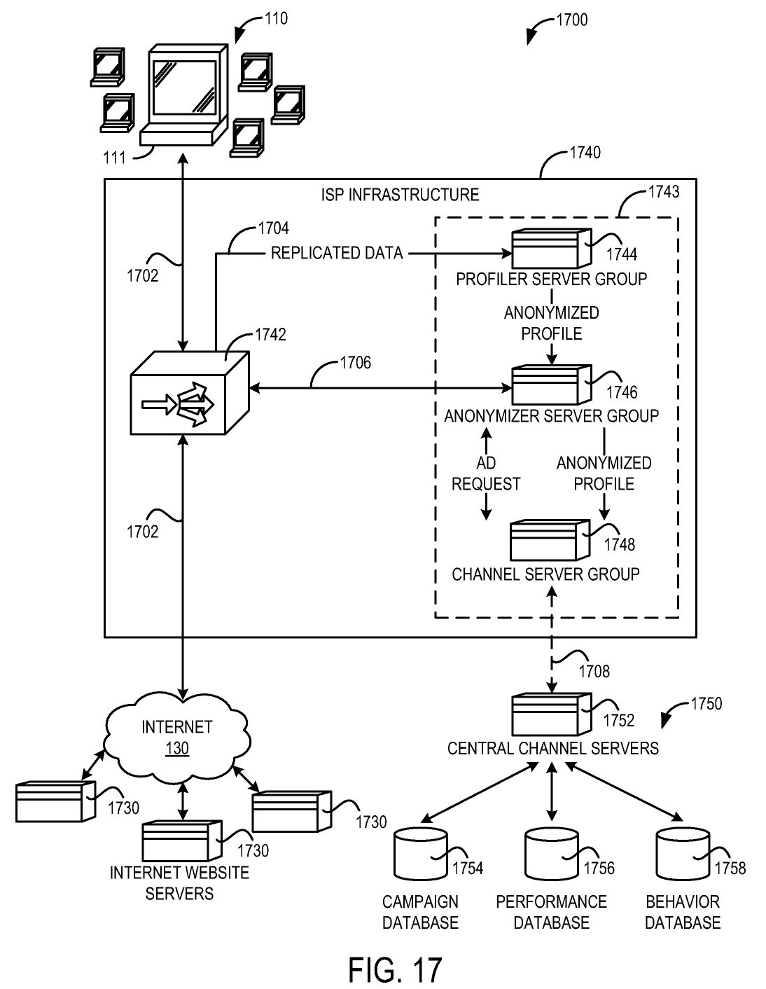

As previously described with reference to FIG. 1, one or more monitors may be associated with or operated within the infrastructure of the client's ISP to allow observation of the client's behavior/interaction relative to the Internet. FIGS. 17, 18, and 19 provide several non-limiting examples of how a monitor may be implemented within the ISP infrastructure. However, it should be appreciated that other approaches for observing client behavior/interaction relative to the Internet may be used where appropriate.

FIG. 17 depicts a first example of an ISP infrastructure including a monitor. Network 1700 includes a plurality of clients 110 communicating with one or more website servers 1730 via the Internet 130 or other suitable wide area network (WAN). Each of the clients can exchange data with the Internet via ISP 1740. Over the course of a particular session, a client may browse one or more web pages by exchanging data with one or more of the website servers. In this way, the ISP can facilitate the exchange of data between the client and the Internet as indicated by data stream 1702.

In this particular example, ISP 1740 may include, among other features, a switching device 1742 that is configured to redirect selected portions of the data stream to ISP server system 1743. Switching device 1742 may include a Layer-7 switch, a deep packet inspection device, a router, a load balancing device, or other suitable device. In some examples, switching device 1742 can be configured to redirect only Hypertext Transfer Protocol (HTTP) data designated on port 80 (or alternatively on port 81) to ISP server system 1743 as indicated at 1706. Additionally, switching device 1742 can direct data from the ISP server system to the Internet or client via the data stream.

Server system 1743 may include one or more servers for analyzing and identifying select portions of the data stream attributable to a particular client. For example, ISP server system 1743 may include a profiler 1744, an anonymizer 1746 including an HTTP proxy, and/or a channel server 1748. The ISP server system 1743 can further communicate with a centralized channel server system 1750 of a moderator. Note that the centralized channel server system can also communicate with other independent ISP server systems in addition to ISP 1740 to enable centralized control and/or sharing of data among the plurality of ISPs. Centralized channel server system 1750 may include one or more channel servers that each may include a campaign database 1754, a channel performance database 1756, and/or a behavioral information database 1758.

Campaign database 1754 can include a plurality of campaigns that indicate channels and/or associated content that may be provided to the ISPs, where the content can be in turn provided to the clients responsive to their activation of one or more channels. Channel performance database 1756 can include channel performance information that has been obtain from feedback indicative of channels previously selected by channel server 1748, residing at the ISP level. Behavioral database 1758 can receive feedback from each of the ISP server systems indicative of client response to the content (e.g. advertisements) as well as derivative information obtained from the datastream attributable to each client of the client pool. Thus, in at least some examples, the moderator and/or ISPs can identify client behavior and network activity across a plurality of different ISP interactions.

Continuing with FIG. 17 data transferred between client 111 and internet 130 may be received and identified at switching device 1742 of ISP 1740 as indicated at 1702. For example, client 111 may request a webpage from an Internet website server 1730 by way of an HTTP request on port 80 as indicated at 1702. Note that the data may also include HTTP response data from the Internet website server to the client via the Internet. If the data stream passing through switching device 1742 does not include HTTP data, then the data stream may be passed to the Internet by the switching device. In this way, non-HTTP data may be passed through the switching device without being redirected to the ISP server system.

Alternatively, if the data includes HTTP data, for example, on port 80, but does not include a unique identification (UID) tag, then the HTTP data may be passed to the anonymizer server via the switching device as indicated by 1706. The anonymizer server may then return a binding redirect (e.g. via a proxy located at the anonymizer) that sets a master UID tag at the client browser, a process that may be referred to as binding. As one example, the master UID tag may be set at the browser by a Layer-3 redirect or other suitable Open Systems Interconnection (OSI) based model.

As one example, the anonymizer server can send a cookie to the client browser that causes each HTTP data request issued by the client to include a copy of the master UID tag. After the master UID tag is set at the client browser, the anonymizer can forward the HTTP data to the Internet (e.g. via a proxy), whereby the requested data is in turn provided to the client. Note that each client of the plurality of clients communicating with the Internet via the ISP can be referenced in this manner by each being assigned a different UID tag. The UID tag assigned to each client may include a randomly generated and unique identifier. For example, each client may be assigned an associated UID that is not indicative of their respective IP address. In this way, a particular client may not be identified by the UID for purposes of determining the identity of the client user, thereby maintaining the client's privacy during the acquisition of their network activity.

If the UID tag is present in the HTTP data, then the HTTP data may be passed to the Internet and a read-only copy of the HTTP data including the UID tag may be provided to the profiler server group by the switching device. The profiler can be configured to identify certain derivative information from the HTTP data for the associated UID tag. Examples of this derivative information include the Uniform Resource Locator (URL) associated with the HTTP data, keywords contained in the HTTP data, and/or search queries initiated by the client. For example, Hypertext Markup Language (HTML) contained in the HTTP data may be analyzed by the profiler server, whereby certain keywords are identified and/or counted. In some examples, the profiler may identify only select keywords as specified by the ISP or the moderator. In some cases, the profiler can explicitly ignore data received from form fields of web pages, email addresses, and/or numbers containing more than a prescribed quantity of digits (e.g. ignore numbers with four or more digits). Furthermore, the profiler can compile a list of the most common, relevant keywords in the web pages requested by the client browser. Further still, the profiler can rank these keywords based on their frequency (e.g. number of occurrences) on each of the requested web pages and/or the density of keywords in a particular portion of text on the web pages.

The profiler can provide a digest of information to the anonymizer, including the derivative information obtained from the HTTP data with the associated UID. The derivative information can be stored at the anonymizer in a profile database for each of the associated UIDs. For each new UID received by the anonymizer, it can create a new profile and periodically update the appropriate existing profile for each existing UID in response to derivative information obtained from the network activity of the UID by the profiler. This digest of information, including the derivative information, can be provided to the anonymizer by the profiler with each HTTP data request (e.g. for each webpage loaded or requested by the browser). The anonymizer can discard any non-anonymous identifiers such as the client's IP address, to maintain client anonymity.

If the HTTP data includes an advertisement request tag addressed to the ISP, then the anonymizer server can receive the advertisement request including the UID tag associated with the client, and can looks up the profile for the client requesting the advertisement based on the corresponding UID. Alternatively, if the advertisement tag is addressed to another location communicating with the client via the Internet, then the switching device can pass the advertisement request to the Internet. The anonymizer can forward the advertisement request to the channel server with the profile for the appropriate UID. Note that the anonymizer can discard select information from the profile before forwarding the profile to the channel server. For example, the anonymizer can discard the non-anonymous identifiers, such as the IP address of the client, to maintain client anonymity.

The channel server can select at least one channel from a plurality of channels stored at the channel server group. The channel server can select a channel from the plurality of channels by comparing the profile provided by the anonymizer with triggering conditions associated with each channel. The channel server can provide the selected channel to the anonymizer, where the anonymizer can update the session information stored in the profile based on the selected channel. If an advertisement indicated by the channel is stored locally at the ISP server system, for example, at the channel server group or within the ISP server system, the advertisement may be provided to the client via the anonymizer. Alternatively, if the advertisement resides at a location external the ISP server system, then a request for the appropriate advertisement can be forwarded to the Internet.

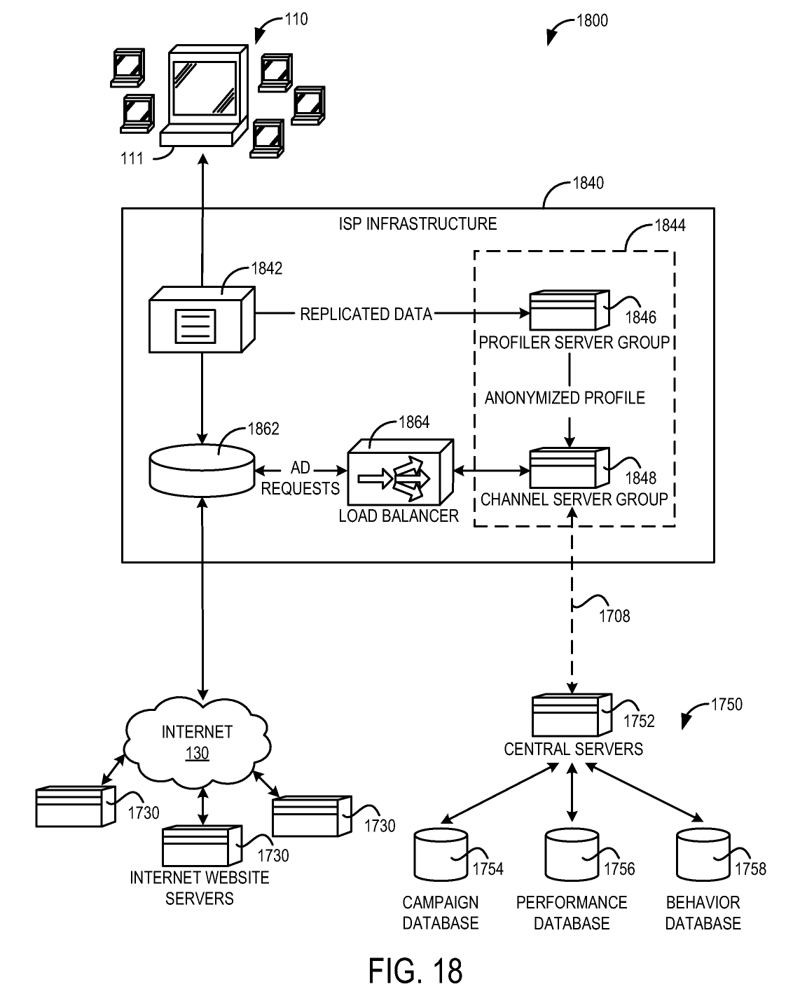

FIG. 18 depicts a second example of an ISP infrastructure including a monitor, which can provide some of the same advantages as the first example shown in FIG. 17 as well as additional advantages including a further reduction of network latency. FIG. 18 shows a schematic depiction of an example client network 1800. Network 1800 can be similar to network 1700 in many respects. However, network 1800 in this example includes an ISP 1840 that can monitor client activity in a different manner.

For example, ISP 1840 may utilize a data replicating device such as a network tap 1842 that is configured to replicate network traffic between the clients of the ISP and the Internet. The replicated data stream (e.g. the HTTP data request or response) can be provided to the profiler of the ISP server system 1844 via the network tap, while the original data stream proceeds uninterrupted between the clients and the Internet. In this way, network latency may be further reduced as compared to the example of FIG. 17 since the monitoring does not redirect the original data stream. Instead, the profiler can utilize what may be referred to as a heuristics based approach to identify which portion of the data stream is attributable to a particular client of the ISP, by examining the copy or replicated version of the data stream.

As one example of a heuristics based approach, the profiler can compare IP addresses, user-agent information, and/or browsing patterns associated with each of a plurality of data requests or data responses to client information stored in the client profiles. When the profiler identifies a new IP address, it can assign or associate a new temporary UID with the new IP address and accompanying user-agent information. User-agent information as described herein can include the type and/or version of the client's browser and/or operating system as may be detected by the ISP.

As the profiler receives one or more subsequent data requests or data responses attributable to the IP address (e.g. either as the source or the target of the data request or response), the profiler server can distinguish multiple clients or client users utilizing the same or different IP addresses based on a comparison of their browsing behavior (e.g. matching data requests with data responses) and/or client-agent information. Furthermore, users may be identified and/or distinguished from each other even when the UID object (e.g. cookie) is not set during binding. For example, two navigations can be identified as belonging to the same user by analyzing HTTP referrers and cookies from the two data requests.

As the portion of the data attributed to the network activity of each client is identified using the heuristics based approach, the ISP server system can obtain derivative information from the data stream for each client. In contrast to the function performed by the profiler in the first example of FIG. 17 profiler server group 1846 is configured to create profile for the client without redirecting the data stream.

The derivative information attributed to a particular client can be stored in a profile for the client by assigning the client a temporary UID. In contrast to the UID tag provided to the profiler in the first example, the temporary UID may be instead assigned to the data attributed to the particular client without reading the UID tag directly from the data stream. As the client continues to request and receive data over their network session, the profiler can provide the profile to the channel server system. Note that in some examples, the profiler can discard the IP address of client, thereby anonymizing the profile. In turn, the channel server system can utilize the profile provided by the profiler to select at least one channel from the channel database. As previously described with reference to the first example of FIG. 17 each channel of the channel database may include one or more associated triggering conditions that are activated in response to information contained in the profile.

The channel server can then return updated session information (e.g. a cookie or state object) indicative of the selected channel or selected content (e.g. advertisement) to the profiler. In other examples, the channel server can return the actual content such as an advertisement, which can be stored in a cache at the profiler from which it may be later provided to the client. The profiler can then update the profile for the temporary UID based on the updated session information received from the channel server and/or selected content.

As a result of the selected advertisement, the channel server can supply the advertisement to be shown in the advertisement slot on the webpage. For example, the channel server can generate the appropriate HTML or JavaScript code of the advertisement. Alternatively, where the advertisement is stored external to the ISP server system, the channel server may forward a request for the selected advertisement to a content provider located external to the ISP, whereby the advertisement may be provided to the client from the content provider.

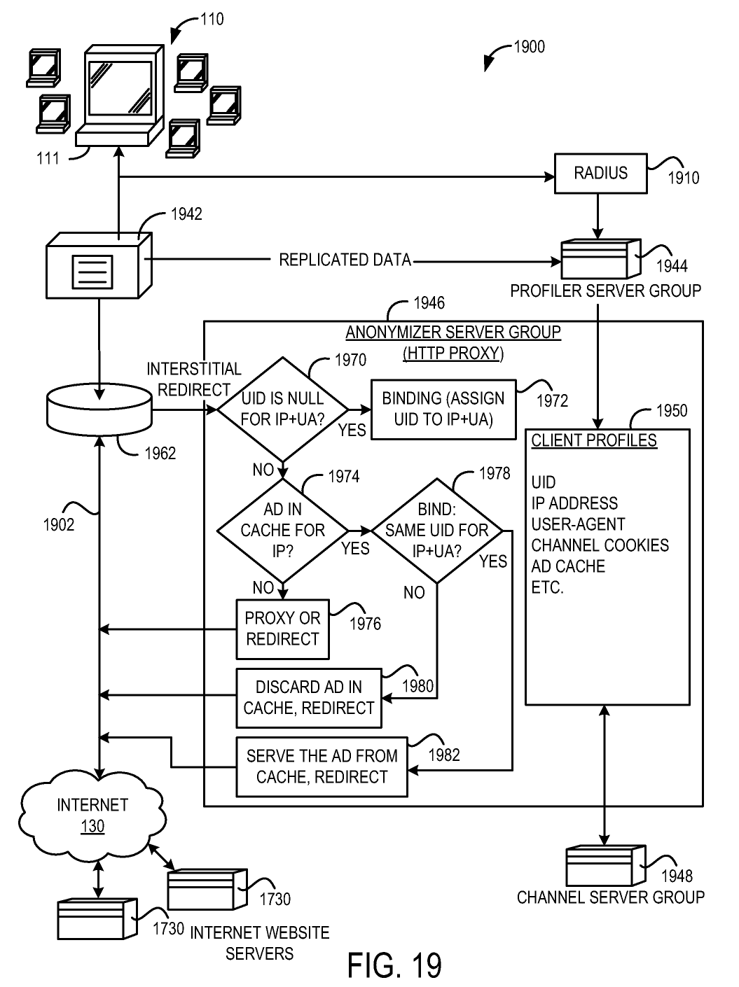

FIG. 19 depicts a third example of an ISP infrastructure including a monitor. Network 1900 is similar to networks 1700 and 1800 in many respects. For example, network 1900 may also include a data replicating device such as a network tap 1842 described with reference to FIG. 18, which may be configured to replicate network traffic between the network clients and the Internet. Data that is replicated by network tap 1942 can be provided to a profiler server group 1944.

Profiler 1944 in this example can again apply the heuristics based approach of the second example to attribute portions of the data stream to a particular client. Profiler 1944 can also update a client profile for each of the clients as described with reference to the first and second embodiments. Furthermore, in this example, profiler server group 1944 can receive information from RADIUS 1910 indicative of whether a new client or client user has requested access to the WAN (e.g. Internet) via the ISP. For example, RADIUS 1910 can provide an indication to the profiler that a client is initiating a new session. At the start of a session, the UID may be unknown for the IP address and/or user-agent identified by the profiler. Thus, the UID may be bound on the first domain transition performed by the client, wherein the UID is associated with the client's IP address and/or user-client at the profile. When the IP address is reallocated, for example, upon initiation of a new session by the client as identified by the profiler via input from the RADIUS, any profiles associated with the same IP address may be discarded from memory.

Profiler 1944 can periodically provide profile information to anonymizer 1946, which in this example may also include an HTTP proxy. For example, for each webpage viewed by the client, the profiler can send a channel request to the channel server via the anonymizer. When making this request, the anonymizer can discard the client IP address. Alternatively, the IP address information can be discarded from the profile information by the profiler. The profile information including a temporary or permanent UID, IP address of the client and user agent, and derivative information among other parameters that is received from profiler 1944 can be stored at the anonymizer's profile database 1950.

The advertisements or other content can be stored in a cache (e.g. an advertisement cache) at profile database 1950 where they may be served to the client under select conditions. Similarly, channel cookies indicating content to be delivered to the client, past content delivered to the client, or other content selection information can be obtained from channel server group 1948 where they may be stored at profile database 1950.

The third example shown in FIG. 19 provides at least some advantages over the second example shown in FIG. 18, in that interstitial advertisements may be served to the client as the client transitions between Internet domains. For example, router or switching device 1962 can be configured to redirect portions of the data stream to anonymizer server group 1946 under select conditions. As one example, an interstitial redirect may be provided when an HTTP port 80 data request for a transition from a first domain to a second domain is requested and can be redirected to anonymizer server group 1946 via router 1962. For example, the UID may be bound on the first domain transition by the client after the initiation of a new session, whereby the client profile is initially created and populated with derivative information via the profiler. Some domain transitions may not be routed to the anonymizer, but may instead pass to the Internet when the requested file or URL extension matches a predefined term. For example, extensions that reference photographs or videos (e.g. .gif, .jpg, etc.) may be passed to the Internet without being redirected to the anonymizer.

As indicated at 1970, if the UID associated with the domain transition request is null (e.g. unavailable) for the IP address and user-agent information, binding may be performed as indicated at 1972, whereby the UID is assigned to or associated with the IP address and the user-agent information stored in the profile. For example, the anonymizer can identify whether the IP address and/or user-agent attributable to the domain transition request references a UID stored in the profile. If not, this association of the UID with the IP address and/or user-agent information can be stored at profile database 1950 for the client. Furthermore, this approach can be performed by the anonymizer for each of the plurality of clients 110 as they request domain transitions. As one example, the decision at 1970 may be performed by way of a Layer-4 switch.

The HTTP proxy for the anonymizer in first and third examples may include one or more of a Layer-4 software switch and a Layer-7 switch based on the Open Systems Interconnection (OSI) model. As one example, whereby the HTTP proxy operates on Layer-7 of the OSI model (Application Level) when the data stream is passed through the proxy, the HTTP connection may be terminated on the proxy, and the proxy can create a new HTTP connection to the end-user (e.g. client or other suitable destination). By contrast, a Layer-4 (Transmission Control Protocol (TCP) Level) proxy doesn't terminate on the HTTP level, but only on the TCP level, which can further reduce system latency as a new HTTP does not need to be made to the end-user.

Returning to 1970, if the UID associated with the domain transition request is not null for the IP address and/or user-agent information attributable to the client associated with the request, then it may be judged whether content such as an interstitial advertisement is stored in the cache (e.g. advertisement cache) at the profile. If the advertisement or other content is stored in the cache for the IP address, then it may be judged whether to perform binding as indicated at 1978. Binding in this example may include redirecting the client browser to a pre-selected domain where a UID cookie can be set at the browser such that future data attributed to the client includes the UID. This binding approach may be performed in a similar manner as described with reference to the first example of FIG. 17.

If the answer at 1978 is no, the advertisement or other content stored in the cache for the UID may be discarded and the client may be redirected to the originally requested webpage. Alternatively, if the answer at 1978 is yes, an interstitial advertisement or other content may be served to the client before the client is redirected to the originally requested webpage. Otherwise, if at 1974 the advertisement or other content is not available from the cache, then the data request issued by the client and received from the data stream can be proxied, whereby the originally requested data is provided to the client.

While not shown in FIG. 19, channel server group 1948 can also communicate with a central channel server, as indicated by 1750 in FIGS. 17 and 18. It should be appreciated that some or all of the various components described herein including the profiler, RADIUS, anonymizer, and channel server group can reside at the ISP level. As one example, the RADIUS, the profiler, anonymizer, and/or channel server group can comprise one or more servers and can be provided by a common ISP server or by a plurality of independent ISP servers.

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various configurations and method implementations, and other features, functions, and/or properties disclosed herein. Claims may be presented that particularly point out certain combinations and subcombinations regarded as novel and nonobvious. Such claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for monitoring client Internet activity, comprising:
a channel server including multiple channels, each of which are defined at least in part by an activity profile associated with the channel; and
a monitor configured to monitor Internet activity of a plurality of clients and detect when any of the monitored clients satisfy any of the activity profiles associated with the channels, where for a given user, the monitor is configured to monitor interaction of the user in relation to multiple different independent websites to determine if one of the activity profiles is satisfied.

2. The system of claim 1, where for each of the monitored clients, the system is configured to cause delivery of targeted advertising to the client, where specific content of the targeted advertising is dependent upon which of the channels is active for the client, as determined by monitored Internet activity of the client obtained by the monitor.

3. The system of claim 1, where for each of the monitored clients, the system is configured to cause variation in responses to outbound network requests issuing from the client, such variation being dependent upon which of the channels is active for the client, as determined by monitored Internet activity of the client.

4. The system of claim 1, further comprising:
a search interface configured to receive an input query and return one or more of the channels as search results in response to the input query; and
a channel tool configured to enable portions of the search results to be selected and used to implement a desired channel within the channel server.

5. The system of claim 4, where the channel tool is configured to enable Boolean combinations of at least portions of multiple different ones of the channels.

6. The system of claim 1, where the channel server and monitor are operated within an Internet Service Provider (ISP).

7. The system of claim 1, where the monitor is configured to anonymously identify, for each channel, all of the monitored clients that satisfy the activity profile associated with the channel.

8. A system for matching Internet users with an activity profile, comprising:
a user interface that allows a user to create a channel which is defined in part by an activity profile; and
a channel monitoring system located and operating within an Internet Service Provider (ISP), the channel monitoring system being configured to:
receive the channel created with the user interface; and
monitor Internet activity of multiple clients that connect to the Internet through the ISP to determine when and whether any of those clients satisfy the activity profile of the channel, where the channel monitoring system is configured, for each of the clients, to monitor Internet activity of that client across multiple different unaffiliated websites to determine whether the activity profile has been satisfied.

9. The system of claim 8, where the user interface includes a search interface configured to receive an input query and return one or more pre-existing channels as search results in response to the input query, and a channel editor configured to enable a user to select and use portions of the search results to create the channel.

10. The system of claim 9, where the channel editor is configured to enable Boolean combinations of at least portions of multiple different ones of the pre-existing channels.

11. The system of claim 9, where the search results include channels having different usage terms.

12. The system of claim 11, where the search results include a channel having usage terms that make use of the channel available for a fee.

13. The system of claim 12, where the fee is calculated on a cost-per-impression basis in relation to advertising content delivered through the channel.

14. The system of claim 12, where the fee is calculated on a cost-per-click basis in relation to advertising content delivered through the channel.

15. The system of claim 12, where the fee is calculated on a cost-per-action basis in relation to advertising content delivered through the channel.

16. The system of claim 11, where the search results include a channel having usage terms that specify the activity profile of the channel is freely viewable and that the channel may be used free of charge.

17. The system of claim 8, where the channel monitoring system includes a channel server configured to store multiple different channels with different activity profiles, and where the channel monitoring system is configured to monitor Internet activity of the clients to identify matches with the different channels.

18. The system of claim 8, where the user interface is configured to enable the user to specify targeted advertising content to be delivered to clients satisfying the activity profile.

19. A method of varying client-Internet interaction based upon prior Internet activity of a client device, comprising:
receiving a set of behavioral search parameters at a central server;
distributing the set of behavioral search parameters to a plurality of distributed monitoring domains;
receiving behavioral tracking data at each of the plurality of distributed monitoring domains, such behavioral tracking data being dynamically acquired from client devices within each domain based upon Internet activity of the client devices; and
varying a response to an Internet request of one of the client devices, such variation being based upon a comparison of the set of behavioral search parameters and the Internet activity of such client device.

20. The method of claim 19, where each of the distributed monitoring domains is associated with an Internet Service Provider (ISP).

21. The method of claim 20, where for each distributed monitoring domain, the associated ISP hosts a server system configured to: (a) compare the set of behavioral search parameters and behavioral tracking data, and (b) initiate the response variation when such comparison indicates a match.

22. The method of claim 21, where the response variation includes targeted advertising.

23. The method of claim 19, further comprising storing a plurality of sets of behavioral search parameters at the central server.

24. The method of claim 23, further comprising providing an interface configured to enable users to access and make use of the stored sets of behavioral search parameters.

25. The method of claim 24, where the interface is configured to enable a user to combine aspects of two or more of the sets of behavioral search parameters using a logical operator.

26. The method of claim 23, further comprising managing a market/exchange at the central server, whereby owners of sets of behavioral search parameters can transact with users for a right to make use of the sets of behavioral search parameters.

27. The method of claim 26, wherein managing said market/exchange at the central server includes facilitating an auction between two or more users for the right to use the sets of behavioral search parameters.

28. The method of claim 26, wherein said managing a market/exchange at the central server includes facilitating financial transactions between the users and the owner of the sets of behavioral search parameters in exchange for the right to make use of the sets of behavior search parameters.

29. A system for monitoring client Internet activity, comprising:
a channel store accessible from a central channel server and having a plurality of stored channels, where each channel specifies behavioral search parameters that correlate to and are triggered by specified Internet browsing activity of a client device; and
a channel interface operatively coupled with the channel store and configured to enable activation of a desired channel, whereupon the central channel server is configured to distribute the desired channel to each of a plurality of distributed monitoring domains that are each configured to monitor Internet browsing activity of a plurality of client devices to identify triggering of the desired channel.

30. The system of claim 29, where the channel interface is configured to accept user inputs to cause activation of the desired channel.

31. The system of claim 30, where the user inputs include a search query and a selection of one or more of the stored channels that are returned as results to the search query.

32. The system of claim 30 where the user inputs include selection of one of the stored channels and agreement to usage terms associated with said one of the stored channels.

33. The system of claim 32, where the usage terms specify a fee for usage of said one of the stored channels.

34. The system of claim 30, where the user inputs include association of a logical operator with one or more channels.

35. The system of claim 34, where the users inputs specify a Boolean combination of multiple different channels.

36. The system of claim 29, where the channel interface is configured to accept user inputs to create and modify behavioral search parameters of an existing channel, or of a new channel to be added to the channel store.

37. The system of claim 36, where the acceptable user inputs include specified keywords present on web pages viewed with a client device.

38. The system of claim 36, where the acceptable user inputs include specified URLs visited with a client device.

39. The system of claim 36, where the acceptable user inputs include specified search terms applied from a client device to a search engine.

40. The system of claim 36, where the user inputs include time/proximity constraints.

41. The system of claim 40, where the time/proximity constraints include specification that a specified web activity must have occurred within a set number of page views.

42. The system of claim 40, where the time/proximity constraints include specification that a specified web activity must have occurred within a set period of time.

43. The system of claim 29, where the channel interface is configured to enable a creator of a channel to specify usage terms upon which the channel will be offered for use by others.

44. The system of claim 29, where the channel interface is operable as a front-end for an electronic channel marketplace, which is configured to enable marketplace users to:
search the channel store for channels of interest;
view performance statistics and usage terms for the channels of interest; and
transact to use a selected channel or channels of interest.

45. The system of claim 44, where the channel interface is configured to enable Boolean combinations of channels of interest.

46. The system of claim 29, where the channel interface is configured to enable correlation of a desired action with triggering of the desired channel.

47. The system of claim 46, where the desired action is provision of selected content to client devices that trigger the desired channel.

48. The system of claim 47, where the selected content is an advertisement.
